(19) United States
(12) Patent Application Publication
(10) Pub. No.: US 2026/0106227 A1
(43) Pub. Date: Apr. 16, 2026

(54) ELECTRODE, SECONDARY BATTERY AND METHOD FOR MANUFACTURING ELECTRODE

(71) Applicant: SAMSUNG SDI CO., LTD., Yongin-si (KR)

(72) Inventors: Hanbyeol JANG, Yongin-si (KR); Taesu JEONG, Yongin-si (KR); Jungah YOON, Yongin-si (KR); Eunhyeok SHIN, Yongin-si (KR)

(21) Appl. No.: 19/307,296

(22) Filed: Aug. 22, 2025

(30) Foreign Application Priority Data
Oct. 15, 2024 (KR) 10-2024-0140130

(51) Int. Cl. H01M 10/0585; H01M 10/052; H01M 50/105; H01M 50/536; H01M 50/54

(52) U.S. Cl. CPC H01M 10/0585; H01M 10/052; H01M 50/105; H01M 50/536; H01M 50/54

(57) ABSTRACT

An electrode includes an electrode substrate including an insulating layer and a first conductive layer on opposite sides of the insulating layer, a composite portion having an active material thereon in an area of the electrode substrate, an uncoated portion having no active material thereon in another area of the electrode substrate, and a second conductive layer on the first conductive layer in the uncoated portion.

### CROSS-REFERENCE TO RELATED APPLICATION

This application claims priority under 35 U.S. C § 119 to Korean Patent Application No.10-2024-0140130, filed in the Korean Intellectual Property Office on Oct. 15, 2024, the entire contents of which are hereby incorporated by reference.

### BACKGROUND

### 1. Field

The present disclosure relates to an electrode, a secondary battery, and a method of manufacturing the electrode.

### 2. Description of the Related Art

Unlike primary batteries that are not designed to be (re)charged, secondary (or rechargeable) batteries are batteries that are designed to be discharged and recharged. Low-capacity secondary batteries are used in portable, small electronic devices, such as smart phones, feature phones, notebook computers, digital cameras, and camcorders, while large-capacity secondary batteries are widely used as power sources for driving motors in hybrid vehicles and electric vehicles and for storing power (e.g., home and/or utility scale power storage). A secondary battery generally includes an electrode assembly composed of a positive electrode and a negative electrode, a case accommodating the same, and electrode terminals connected to the electrode assembly.

The above information disclosed in this Background section is for enhancement of understanding of the background of the present disclosure, and therefore, it may contain information that does not constitute related (or prior) art.

### SUMMARY

Embodiments include an electrode, including an electrode substrate including an insulating layer and a first conductive layer on opposite sides of the insulating layer, a composite portion having an active material thereon in an area of the electrode substrate, an uncoated portion having no active material thereon in another area of the electrode substrate, and a second conductive layer on the first conductive layer in the uncoated portion.

A second thickness of the second conductive layer may be greater than a first thickness of the first conductive layer.

A ratio of the first thickness and the second thickness is 1:3 to 1:4.

The second conductive layer may be spaced apart from the composite portion at one end of the uncoated portion.

The first conductive layer and the second conductive layer may include a same conductive material.

The electrode may further include an electrode tab welded onto the second conductive layer.

If the electrode is a positive electrode, a ratio of thicknesses of the insulating layer and the first conductive layer may be 3:1 to 4:1, and if the electrode is a negative electrode, the ratio of the thicknesses of the insulating layer and the first conductive layer may be 2:1 to 3:1.

Embodiments include a secondary battery, including an electrode assembly including a first electrode, a second electrode, and a separator between the first electrode and the second electrode, and a case accommodating the electrode assembly, wherein at least one of the first electrode and the second electrode includes an electrode substrate including an insulating layer and a first conductive layer on opposite sides of the insulating layer, a composite portion having an active material thereon in an area of the electrode substrate, an uncoated portion having no active material thereon in another area of the electrode substrate, and a second conductive layer on the first conductive layer in the uncoated portion.

A second thickness of the second conductive layer may be greater than a first thickness of the first conductive layer.

A ratio of the first thickness and the second thickness may be 1:3 to 1:4.

The second conductive layer may be spaced apart from the composite portion at one end of the uncoated portion.

The first conductive layer and the second conductive layer may include a same conductive material.

The secondary battery may further include an electrode tab welded onto the second conductive layer.

The secondary battery may further include an electrode tab connected to each of a plurality of the first electrode or a plurality of the second electrode and a lead tab connected to the electrode tab.

Embodiments include a method of manufacturing an electrode, the method including disposing a first conductive layer by a first deposition of a first conductive material on opposite sides of an insulating layer, disposing a composite portion by applying an active material onto an area on the first conductive layer, and disposing a second conductive layer by a second deposition of a second conductive material onto another area on the first conductive layer.

Disposing the second conductive layer may include disposing the second conductive layer having a second thickness greater than a first thickness of the first conductive layer.

A ratio of the first thickness and the second thickness may be 1:3 to 1:4.

Disposing the second conductive layer may include disposing the second conductive layer spaced apart from the composite portion at one end of the first conductive layer.

The first conductive material and the second conductive material may be a same material.

The method may further include welding an electrode tab onto the second conductive layer.

However, the technical problem to be solved by the present disclosure is not limited to the above problem, and other problems not mentioned herein, and aspects and features of the present disclosure that would address such problems, will be clearly understood by those skilled in the art from the description of the present disclosure below.

However, aspects and features of the present disclosure are not limited to those described above, and other aspects and features not mentioned will be clearly understood by a person skilled in the art from the detailed description, described below.

### BRIEF DESCRIPTION OF THE DRAWINGS

The following drawings attached to this specification illustrate embodiments of the present disclosure, and further describe aspects and features of the present disclosure together with the detailed description of the present disclosure. Thus, the present disclosure should not be construed as being limited to the drawings.

Features will become apparent to those of ordinary skill in the art by describing in detail exemplary embodiments with reference to the attached drawings, in which:

FIG. 1 shows an example of a secondary battery according to an embodiment of the present disclosure;

FIG. 2 shows an electrode according to an embodiment of the present disclosure;

FIG. 3 shows a cross-section taken along line A-A in FIG. 2;

FIG. 4 shows an electrode according to an embodiment of the present disclosure;

FIG. 5 shows a cross-section taken along line B-B in FIG. 4;

FIG. 6 shows a process of forming an electrode according to an embodiment of the present disclosure;

FIG. 7 shows a process of forming an electrode according to an embodiment of the present disclosure;

FIG. 8 shows a process of forming an electrode according to an embodiment of the present disclosure;

FIG. 9 shows a process of forming an electrode according to an embodiment of the present disclosure;

FIG. 10 shows an example of an electrode assembly according to an embodiment of the present disclosure; and

FIG. 11 illustrates a method of manufacturing an electrode according to an embodiment of the present disclosure.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figures, the dimensions of layers and regions may be exaggerated for clarity of illustration. It will also be understood that when a layer or element is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present. Like reference numerals refer to like elements throughout.

Hereinafter, embodiments of the present disclosure will be described, in detail, with reference to the accompanying drawings. The terms or words used in the present specification and claims are not to be limitedly interpreted as general or dictionary meanings and should be interpreted as meanings and concepts that are consistent with the technical idea of the present disclosure on the basis of the principle that an inventor can be his/her own lexicographer to appropriately define concepts of terms to describe his/her invention in the best way.

The embodiments described in this specification and the configurations shown in the drawings are only some of the embodiments of the present disclosure and do not represent all of the technical spirit, aspects, and features of the present disclosure. Accordingly, it should be understood that there may be various equivalents and modifications that can replace or modify the embodiments described herein at the time of filing this application.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. § 132(a).

References to two compared elements, features, etc. as being “the same” may mean that they are “substantially the same”. Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

Arranging an arbitrary element “above (or below)” or “on (under)” another element may mean that the arbitrary element may be disposed in contact with the upper (or lower) surface of the element, and another element may also be interposed between the element and the arbitrary element disposed on (or under) the element.

In addition, it will be understood that when a component is referred to as being “linked,” “coupled,” or “connected” to another component, the elements may be directly “coupled,” “linked” or “connected” to each other, or another component may be “interposed” between the components”.

Throughout the specification, when “A and/or B” is stated, it means A, B or A and B, unless otherwise stated. That is, “and/or” includes any or all combinations of a plurality of items enumerated. When “C to D” is stated, it means C or more and D or less, unless otherwise specified.

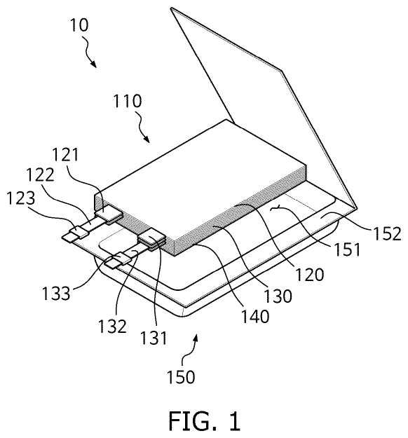

FIG. 1 shows an example of a secondary battery according to an embodiment of the present disclosure.

In the present disclosure, a secondary battery 10 according to an embodiment is described as a pouch-type battery. However, the present disclosure can be applied to other types of batteries such as square batteries. For convenience of description only, a pouch-type battery will be mainly described below.

Referring to FIG. 1, the secondary battery 10 according to an embodiment may include an electrode assembly 110 and a case 150 that accommodates at least a portion of the electrode assembly 110. The secondary battery 10 may further include an electrolyte that is accommodated in the case 150 and permeates through at least a portion of the electrode assembly 110.

According to an embodiment, the electrode assembly 110 may be formed by stacking a first electrode 120, a second electrode 130, and a separator 140 disposed between the first electrode 120 and the second electrode 130, which are formed in the shape of a thin plate or a film. For another example, the electrode assembly 110 may be formed by inserting each of the first electrode 120 and the second electrode 130 onto their corresponding sides of the separator 140 folded in a Z-stack. In addition, one or more of the electrode assembly 110 may be stacked with their long sides adjacent to each other and accommodated inside the case 150, and the number of the electrode assembly 110 may vary. For still another example, the electrode assembly 110 may be formed by winding a laminate where the first electrode 120, the second electrode 130, and the separator 140 are laminated. When the electrode assembly 110 is a wound laminate, the winding axis may be parallel to the longitudinal direction of the case 150. The type of the electrode assembly 110 may vary.

According to an embodiment, the first electrode 120 may be an electrode corresponding to a positive or negative electrode of the secondary battery 10. The second electrode 130 may be an electrode opposite to the first electrode 120. For example, when the first electrode 120 is a positive electrode, the second electrode 130 may be a negative electrode. In contrast, when the first electrode 120 is a negative electrode, the second electrode 130 may be a positive electrode.

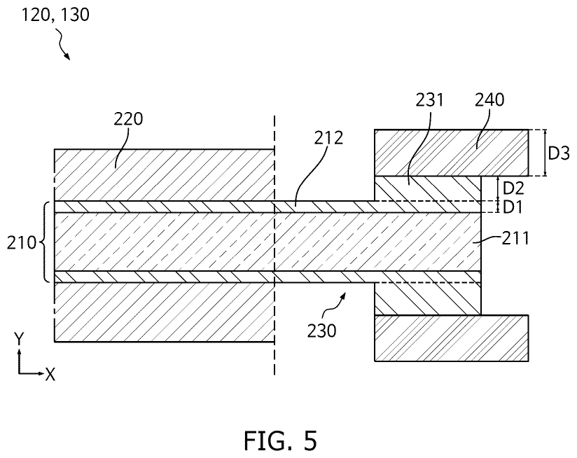

Referring to FIG. 5, at least one of the first electrode 120 and the second electrode 130 according to an embodiment may include an electrode substrate 210 including an insulating layer 211 made of an insulating material and a first conductive layer 212 disposed on both sides of the insulating layer 211. A composite portion 220 where an active material is applied may be formed in an area of the first conductive layer 212, and an uncoated portion 230 where an active material is not applied may be formed in another area thereof. A second conductive layer 231 may be arranged on one end of the first conductive layer 212 of the uncoated portion 230. The first conductive layer 212 and the second conductive layer 231 may include the same conductive material. An electrode tab 240 may be connected to the second conductive layer 231.

By using the insulating layer 211 formed of a polymer material as described above, it may be possible to secure flexibility and lightness of the first electrode 120 and the second electrode 130. The first conductive layer 212 may be formed on both sides of the insulating layer 211 by a deposition process, etc., and the second conductive layer 231 may be formed in an area of the first conductive layer 212. In addition, a path for current may be formed by connecting the second conductive layer 231 and the electrode tab 240. As a result, it may be possible to secure electrical conductivity and battery performance at substantially the same level, compared to an electrode substrate made of a single metal material.

Referring back to FIG. 1, when the first electrode 120 according to an embodiment serves as a positive electrode, a first conductive layer disposed on both sides of an insulating layer may be coated with a metal material such as aluminum or an aluminum alloy. A composite portion may be formed in an area of the first conductive layer. The composite portion may contain a positive electrode active material together with a binder, a conductive material, etc. The positive electrode active material may include, for example, a transition metal oxide.

According to an embodiment, when the first electrode 120 serves as a negative electrode, a first conductive layer disposed on both sides of an insulating layer may be coated with a metal material such as copper, a copper alloy, nickel, or a nickel alloy. A composite portion may be formed in an area of the first conductive layer. The composite portion may contain a negative electrode active material containing a binder, a conductive material, etc. The negative electrode active material may include, for example, graphite.

Of course, when the second electrode 130 also serves as a positive or negative electrode, it may be formed in the same manner as the first electrode 120. When the first electrode 120 serves as a positive electrode, the second electrode 130 may serve as a negative electrode, and when the first electrode 120 serves as a negative electrode, the second electrode 130 may serve as a positive electrode.

According to an embodiment, a first electrode tab 121 may be connected to each of first uncoated portions of a plurality of the first electrode 120 (stacked). The first electrode tab 121 may contain a metal material. A plurality of the first electrode tab 121 connected to each of the first uncoated portions may be formed in the same direction and may be stacked facing each other. Each of the plurality of the first electrode tab 121, which have been stacked, may be electrically connected to the outside by being welded to a first lead tab 122. The first electrode tab 121 and the first lead tab 122 may serve as a current path of an external terminal connected to the first electrode.

According to an embodiment, a second electrode tab 131 may be connected to each of second uncoated portions of a plurality of the second electrode 130 (stacked). The second electrode tab 131 may contain a metal material. A plurality of the second electrode tab 131 connected to each of the second uncoated portions may be formed in the same direction and may be stacked facing each other. Each of the plurality of the second electrode tab 131, which have been stacked, may be electrically connected to the outside by being welded to a second lead tab 132. The second electrode tab 131 and the second lead tab 132 may serve as a current path of an external terminal connected to the second electrode.

A first tab film 123 and a second tab film 133 may be disposed on each of the first lead tab 122 and the second lead tab 132. The first tab film 123 and the second tab film 133 may be placed on one surface of the first lead tab 122 and the second lead tab 132, respectively, or may wrap around both surfaces of the first lead tab 122 and the second lead tab 132. The first tab film 123 and the second tab film 133 may prevent a short circuit occurring when the first lead tab 122 and the second lead tab 132 come into contact with a metal layer exposed on one side of a sealing portion 152 of the case 150. The first tab film 123 and the second tab film 133 be thermally used with the sealing portion 152 to tightly couple the first lead tab 122 and the second lead tab 132 with the sealing portion 152.

According to an embodiment, the case 150 may form the appearance of the secondary battery 10. The case 150 may have the shape of a rectangular solid as shown in FIG. 1, but the shape of the case may vary.

According to an embodiment, the case 150 may include an accommodating portion 151 and the sealing portion 152.

According to an embodiment, the accommodating portion 151 may have an internal space larger than the electrode assembly 110 and may accommodate the electrode assembly 110 and an electrolyte. With the electrode assembly 110 accommodated in the accommodating portion 151, the cover of the case 150 may be lowered to seal the electrode assembly 110.

According to an embodiment, the sealing portion 152 may be disposed along the edge of the case 150. When the electrode assembly 110 has been accommodated in the case 150, each of the sealing portion 152 on the edge of the case 150 may be in contact with each other to be sealed. Here, a portion of each of the first lead tab 122 and the second lead tab 132 may be exposed to the outside of the case 150, and the first tab film 123 and the second tab film 133 may be positioned between the upper and lower portions of the case 150 corresponding to the sealing portion 152.

According to an embodiment, the sealing portion 152 may be made of a heat-melting material and may be sealed by bonding heat-melting layers to each other. For example, because heat-melting materials generally do not adhere well to metals, the first tab film 123 and the second tab film 133 in the form of a thin film may be attached to the first lead tab 122 and the second lead tab 132, respectively, to be fused with the case 150.

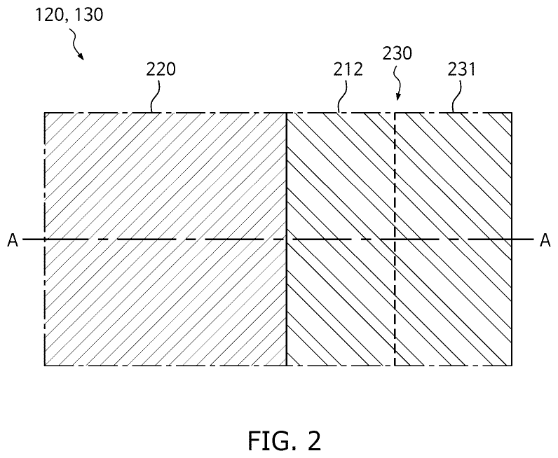

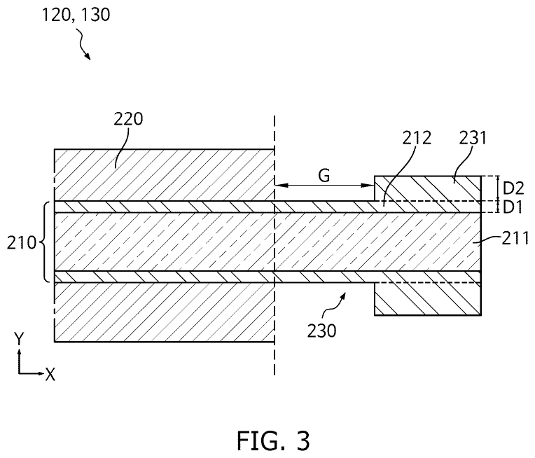

FIG. 2 shows an electrode according to an embodiment of the present disclosure. FIG. 3 shows a cross-section taken along line A-A in FIG. 2.

Referring to FIGS. 2 and 3, the electrode assembly 110 (see FIG. 1) according to an embodiment may include the first electrode 120 and the second electrode 130.

According to an embodiment, at least one of the first electrode 120 and the second electrode 130 may include the electrode substrate 210 including the insulating layer 211 and the first conductive layer 212 disposed on both sides of the insulating layer 211, the composite portion 220 where an active material is applied in an area of the electrode substrate 210, the uncoated portion 230 where an active material is not applied in another area of the electrode substrate 210, and the second conductive layer 231 arranged on the first conductive layer 212 of the uncoated portion 230.

According to an embodiment, the insulating layer 211 may be formed of a polymer material. For example, the insulating layer 211 may be formed of a polyethylene terephthalate (PET) resin. Of course, the material of the insulating layer 211 may be formed of a polyester resin such as polytrimethylene terephthalate (PTT), polybutylene terephthalate (PBT), or polyethylene naphthalate (PEN).

According to an embodiment, the first conductive layer 212 may be disposed on both sides of the insulating layer 211. The first conductive layer 212 may be coated with a metal material, such as copper, a copper alloy, nickel, or a nickel alloy, on the insulating layer 211, or may be coated with a metal material, such as aluminum or an aluminum alloy.

According to an embodiment, when the first conductive layer 212 is formed of aluminum, the composite portion 220 disposed in an area of the first conductive layer 212 may contain a positive electrode active material. In this case, the first electrode 120 may serve as a negative electrode and the second electrode 130 may serve as a positive electrode (and the reverse is also true).

For another example, when the first conductive layer 212 is formed of copper, the composite portion 220 disposed in an area of the first conductive layer 212 may contain a negative electrode active material. In this case, one of the first electrode 120 and the second electrode 130 may serve as a negative electrode.

According to an embodiment, when the one of the first electrode 120 and the second electrode 130 is a positive electrode, the thickness ratio of the insulating layer 211 and the first conductive layer 212 may be 3:1 to 4:1. For example, when the thickness of the insulating layer 211 is about 5 μm, the thickness of the first conductive layer 212 may be about 1.25 μm to about 1.67 μm. However, the thickness of the insulating layer 211 and the first conductive layer 212 may vary depending on design conditions.

According to an embodiment, when the one of the first electrode 120 and the second electrode 130 is a negative electrode, the thickness ratio of the insulating layer 211 and the first conductive layer 212 may be 2:1 to 3:1. For example, when the thickness of the insulating layer 211 is about 5 μm, the thickness of the first conductive layer 212 may be about 1.67 μm to about 2.5 μm. However, the thickness of the insulating layer 211 and the first conductive layer 212 may vary depending on design conditions.

According to an embodiment, the composite portion 220 may be formed by applying an active material onto an area of the electrode substrate 210. When the first conductive layer 212 contains aluminum, the composite portion 220 may be formed by applying a positive electrode active material. When the first conductive layer 212 contains copper, the composite portion 220 may be formed by applying a negative electrode active material.

When the composite portion 220 is formed by applying a positive electrode active material, it may contain the positive electrode active material and may further contain a binder and/or a conductive material.

The positive electrode active material may include a compound (lithiated intercalation compound) that is capable of intercalating and deintercalating lithium. Specifically, at least one of a composite oxide of lithium and a metal selected from cobalt, manganese, nickel, and combinations thereof may be used.

The composite oxide may be a lithium transition metal composite oxide. Specific examples of the composite oxide may include lithium nickel-based oxide, lithium cobalt-based oxide, lithium manganese-based oxide, lithium iron phosphate-based compound, cobalt-free nickel-manganese-based oxide, or a combination thereof.

As an example, the following compounds represented by any one of the following Chemical Formulas may be used. LiaA1-bXbO2-cDc (0.90≤a≤1.8, 0≤b≤0.5, and 0≤c≤0.05); LiaMn2-bXbO4-cDc (0.90≤a≤1.8, 0≤b≤0.5, and 0≤c≤0.05); LiaNi1-b-cCobXcO2-αDα (0.90≤a≤1.8, 0≤b≤0.5, 0≤c≤0.5, and 0<α<2); LiaNi1-b-cMnbXcO2-αDα (0.90≤a≤1.8, 0≤b≤0.5, 0≤c≤0.5, and 0<α<2); LiaNibCocL1dGeO2 (0.90≤a≤1.8, 0≤b≤0.9, 0≤c≤0.5, 0≤d≤0.5, and 0≤e≤0.1); LiaNiGbO2 (0.90≤a≤1.8 and 0.001≤b≤0.1); LiaCoGbO2 (0.90≤a≤1.8 and 0.001≤b≤0.1); LiaMn1-bGbO2 (0.90≤a≤1.8 and 0.001≤b≤0.1); LiaMn2GbO4 (0.90≤a≤1.8 and 0.001≤b≤0.1); LiaMn1-gGgPO4 (0.90≤a≤1.8 and 0≤g≤0.5); Li(3-f)Fe2(PO4)3 (0≤f≤2); or LiaFePO4 (0.90≤a≤1.8).

In the above Chemical Formulas, A is Ni, Co, Mn, or a combination thereof; X is Al, Ni, Co, Mn, Cr, Fe, Mg, Sr, V, a rare earth element or a combination thereof; D is O, F, S, P, or a combination thereof; G is Al, Cr, Mn, Fe, Mg, La, Ce, Sr, V, or a combination thereof; and L1 is Mn, Al, or a combination thereof.

The positive electrode active material may be, for example, a high nickel-based positive electrode active material having a nickel content of greater than or equal to about 80 mol %, greater than or equal to about 85 mol %, greater than or equal to about 90 mol %, greater than or equal to about 91 mol %, or greater than or equal to about 94 mol % and less than or equal to about 99 mol % based on 100 mol % of the metal excluding lithium in the lithium transition metal composite oxide. The high-nickel-based positive electrode active material may be capable of realizing high capacity and can be applied to a high-capacity, high-density rechargeable lithium battery.

For example, the positive electrode may further include an additive that can serve as a sacrificial positive electrode.

An amount of the positive electrode active material may be about 90 wt % to about 99.5 wt % based on 100 wt % of the positive electrode active material layer. Amounts of the binder and the conductive material may be about 0.5 wt % to about 5 wt %, respectively, based on 100 wt % of the positive electrode active material layer.

The binder serves to attach the positive electrode active material particles well to each other and also to attach the positive electrode active material well to the current collector. Examples of the binder may include polyvinyl alcohol, carboxymethyl cellulose, hydroxypropyl cellulose, diacetyl cellulose, polyvinylchloride, carboxylated polyvinylchloride, polyvinylfluoride, a polymer including ethylene oxide, polyvinylpyrrolidone, polyurethane, polytetrafluoroethylene, polyvinylidene fluoride, polyethylene, polypropylene, a styrene-butadiene rubber, a (meth)acrylated styrene-butadiene rubber, an epoxy resin, a (meth)acrylic resin, a polyester resin, nylon, and the like, as non-limiting examples.

The conductive material may be used to impart conductivity (e.g., electrical conductivity) to the electrode. Any material that does not cause chemical change (e.g., does not cause an undesirable chemical change in the rechargeable lithium battery) and conducts electrons can be used in the battery. Examples of the conductive material may include a carbon-based material such as natural graphite, artificial graphite, carbon black, acetylene black, ketjen black, a carbon fiber, a carbon nanofiber, and carbon nanotube; a metal-based material containing copper, nickel, aluminum, silver, etc., in a form of a metal powder or a metal fiber; a conductive polymer such as a polyphenylene derivative; or a mixture thereof.

When the composite portion 220 is formed by applying a negative electrode active material, it may contain the negative electrode active material and may further contain a binder and/or a conductive material.

The negative electrode active material may include a material that reversibly intercalates/deintercalates lithium ions, a lithium metal, a lithium metal alloy, a material capable of doping/dedoping lithium, or a transition metal oxide.

The material that reversibly intercalates/deintercalates lithium ions may include a carbon-based negative electrode active material, such as, for example. crystalline carbon, amorphous carbon or a combination thereof. The crystalline carbon may be graphite such as non-shaped, sheet-shaped, flake-shaped, sphere-shaped, or fiber-shaped natural graphite or artificial graphite. The amorphous carbon may be a soft carbon, a hard carbon, a mesophase pitch carbonization product, calcined coke, and the like.

The lithium metal alloy includes an alloy of lithium and a metal selected from Na, K, Rb, Cs, Fr, Be, Mg, Ca, Sr, Si, Sb, Pb, In, Zn, Ba, Ra, Ge, Al, and Sn.

The material capable of doping/dedoping lithium may be a Si-based negative electrode active material or a Sn-based negative electrode active material. The Si-based negative electrode active material may include silicon, a silicon-carbon composite, SiOx (0<x<2), a Si-Q alloy (where Q is selected from an alkali metal, an alkaline-earth metal, a Group 13 element, a Group 14 element (excluding Si), a Group 15 element, a Group 16 element, a transition metal, a rare earth element, and a combination thereof). The Sn-based negative electrode active material may include Sn, SnO2, a Sn-based alloy, or a combination thereof.

The silicon-carbon composite may be a composite of silicon and amorphous carbon. According to an embodiment, the silicon-carbon composite may be in a form of silicon particles and amorphous carbon coated on the surface of the silicon particles. For example, the silicon-carbon composite may include a secondary particle (core) in which primary silicon particles are assembled, and an amorphous carbon coating layer (shell) on the surface of the secondary particle. The amorphous carbon may also be between the primary silicon particles, and, for example, the primary silicon particles may be coated with the amorphous carbon. The secondary particle may exist dispersed in an amorphous carbon matrix.

The silicon-carbon composite may further include crystalline carbon. For example, the silicon-carbon composite may include a core including crystalline carbon and silicon particles and an amorphous carbon coating layer on a surface of the core.

The Si-based negative electrode active material or the Sn-based negative electrode active material may be used in combination with a carbon-based negative electrode active material.

For example, the negative electrode active material layer may include about 90 wt % to about 99 wt % of the negative electrode active material, about 0.5 wt % to about 5 wt % of the binder, and about 0 wt % to about 5 wt % of the conductive material.

The binder may serve to attach the negative electrode active material particles well to each other and also to attach the negative electrode active material well to the current collector. The binder may include a non-aqueous binder, an aqueous binder, a dry binder, or a combination thereof.

The non-aqueous binder may include polyvinyl chloride, carboxylated polyvinyl chloride, polyvinyl fluoride, an ethylene propylene copolymer, polystyrene, polyurethane, polytetrafluoroethylene, polyvinylidene fluoride, polyethylene, polypropylene, poly amideimide, polyimide, or a combination thereof.

The aqueous binder may be selected from a styrene-butadiene rubber, a (meth)acrylated styrene-butadiene rubber, a (meth)acrylonitrile-butadiene rubber, (meth)acrylic rubber, a butyl rubber, a fluoro rubber, polyethylene oxide, polyvinylpyrrolidone, polyepichlorohydrine, polyphosphazene, poly(meth)acrylonitrile, an ethylene propylene diene copolymer, polyvinylpyridine, chlorosulfonated polyethylene, latex, a polyester resin, a (meth)acrylic resin, a phenol resin, an epoxy resins, polyvinyl alcohol, and a combination thereof.

When an aqueous binder is used as the negative electrode binder, a cellulose-based compound capable of imparting viscosity may be further included. The cellulose-based compound may include at least one of carboxymethyl cellulose, hydroxypropylmethyl cellulose, methyl cellulose, or an alkali metal salt thereof. The alkali metal may include Na, K, or Li.

The dry binder may be a polymer material that is capable of being fibrous. For example, the dry binder may be polytetrafluoroethylene, polyvinylidene fluoride, a polyvinylidene fluoride-hexafluoropropylene copolymer, polyethylene oxide, or a combination thereof.

The conductive material may be used to impart conductivity (e.g., electrical conductivity) to the electrode. Any material that does not cause chemical change (e.g., does not cause an undesirable chemical change in the rechargeable lithium battery) and that conducts electrons can be used in the battery. Non-limiting examples thereof may include a carbon-based material such as natural graphite, artificial graphite, carbon black, acetylene black, ketjen black, a carbon fiber, a carbon nanofiber, and a carbon nanotube; a metal-based material including copper, nickel, aluminum, silver, etc. in a form of a metal powder or a metal fiber; a conductive polymer such as a polyphenylene derivative; or a mixture thereof.

According to an embodiment, the uncoated portion 230 may be another area of the electrode substrate 210 to which no active material is applied. The second conductive layer 231 may be disposed on the first conductive layer 212 of the uncoated portion 230.

According to an embodiment, the second conductive layer 231 may be placed on the first conductive layer 212 of the uncoated portion 230. For example, after the first conductive layer 212 has been deposited and arranged on both sides of the insulating layer 211, the second conductive layer 231 may be deposited and arranged at an area, for example, one end, of the first conductive layer 212.

According to an embodiment, the second conductive layer 231 may be arranged at one end of the uncoated portion 230 and spaced apart from the composite portion 220. For example, the second conductive layer 231 may be placed with a predetermined gap G from the composite portion 220 (e.g., along a longitudinal direction (X-axis) of the insulating layer 211). This may be to prevent a short circuit between the electrode tab 240 and the composite portion 220 when the electrode tab 240 is connected to the second conductive layer 231, as shown in FIG. 5.

According to an embodiment, the second conductive layer 231 may contain the same conductive material as the first conductive layer 212. For example, when the first conductive layer 212 contains aluminum, the second conductive layer 231 may also contain aluminum. For another example, when the first conductive layer 212 contains copper, the second conductive layer 231 may also contain copper. However, the second conductive layer 231 may contain a conductive material different from that of the first conductive layer 212.

According to an embodiment, the second conductive layer 231 may be deposited to a thickness greater than that of the first conductive layer 212. As illustrated in FIG. 3, in a first direction, i.e., a Y-axis direction, a second thickness D2 of the second conductive layer 231 may be greater than a first thickness D1 of the first conductive layer 212. The ratio of the first thickness D1 of the first conductive layer 212 and the second thickness D2 of the second conductive layer 231 may be 1:3 to 1:4. For example, when the first thickness D1 of the first conductive layer 212 is about 1 μm, the second thickness D2 of the second conductive layer 231 may be about 3 μm to about 4 μm. However, the thicknesses of the first conductive layer 212 and the second conductive layer 231 may vary depending on design conditions.

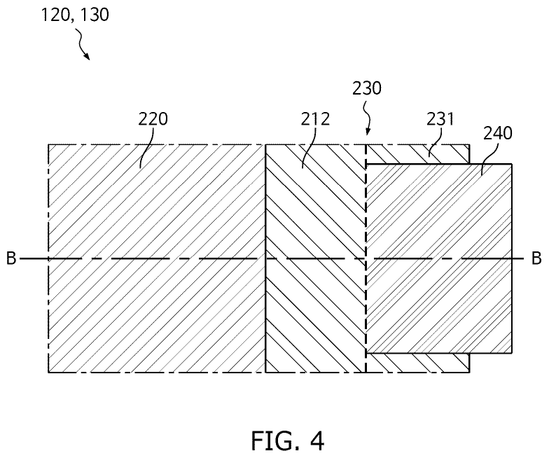

FIG. 4 shows an electrode according to an embodiment of the present disclosure. FIG. 5 shows a cross-section taken along line B-B in FIG. 4.

Referring to FIGS. 4 and 5, the first electrode 120 and 130 according to an embodiment of the present disclosure may further include the electrode tab 240.

According to an embodiment, the electrode tab 240 may be disposed on the second conductive layer 231. For example, the electrode tab 240 may be connected to the second conductive layer 231 by ultrasonic welding or laser welding to be disposed on the second conductive layer 231.

According to an embodiment, the electrode tab 240 may be made of a metal foil such as copper, a copper alloy, nickel, or a nickel alloy, or a metal foil such as aluminum or an aluminum alloy. Of course, the electrode tab 240 may also be made of a metal material having excellent electrical conductivity.

According to an embodiment, in order to prevent the insulating layer 211 from being damaged in the process of welding the electrode tab 240 to the second conductive layer 231, the sum of the second thickness D2 of the second conductive layer 231 and a third thickness D3 of the electrode tab 240 may be greater than a preset thickness, e.g., 6 μm, which is the welding depth. The second conductive layer 231 may be placed between the electrode tab 240 and the first conductive layer 212, so that the insulating layer 211 may not be damaged in the process of connecting the electrode tab 240 to the second conductive layer 231.

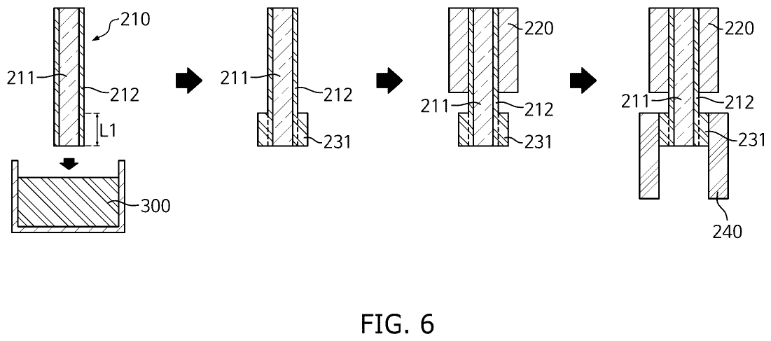

FIG. 6 shows a process of forming an electrode according to an embodiment of the present disclosure.

Referring to FIG. 6, in a first portion of FIG. 6 to the far left, to form the electrode substrate 210, the first conductive layer 212 may be placed on both sides of the insulating layer 211 according to an embodiment of the present disclosure. For example, the first conductive layer 212 may be formed by depositing a first conductive material, e.g., aluminum or copper, on both sides of the insulating layer 211. The first conductive material may be deposited on the insulating layer 211 by a number of PVD processes or sputtering processes, but this may vary.

After the formation of the electrode substrate 210, a second conductive solution 300 that is designated in which a second conductive material is dissolved may be prepared. The second conductive solution 300 may be a solution that reacts with the first conductive layer 212 and does not react with the insulating layer 211. The second conductive solution 300 may react with the first conductive layer 212, so that the second conductive material may be deposited on the first conductive layer 212. By immersing the electrode substrate 210 to a predetermined depth L1, the second conductive material may be deposited on the first conductive layer 212.

In the second portion of FIG. 6 (to the immediate right of the first portion of FIG. 6), the second conductive material deposited on the first conductive layer 212 may be dried, and a planarization process, e.g., a CMP process, and a cleaning process may be performed, thereby forming the second conductive layer 231 on the first conductive layer 212.

In the third portion of FIG. 6, an active material may be applied onto an area spaced apart from the second conductive layer 231 on the first conductive layer 212, thereby forming the composite portion 220.

In the fourth portion of FIG. 6 (to the far right), after the active material has been sufficiently dried, the electrode tab 240 may be welded to the second conductive layer 231.

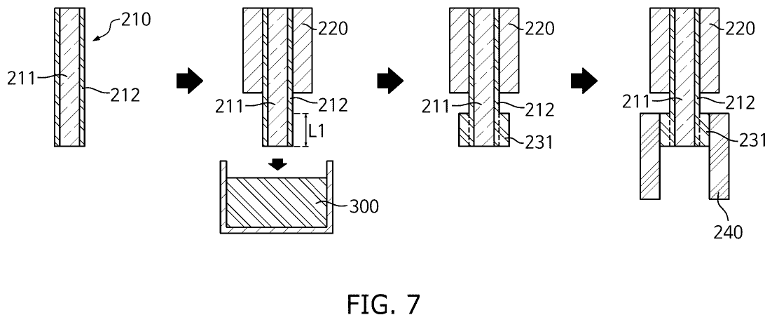

FIG. 7 shows a process of forming an electrode according to an embodiment of the present disclosure.

Referring to FIG. 7, in the first portion of FIG. 7 (to the far left) and the second portion of FIG. 7 (to the immediate right of the first portion), the electrode substrate 210 according to an embodiment may be formed, and an active material may be applied to form the composite portion 220. After the composite portion 220 has been formed, the electrode substrate 210 may be immersed in the second conductive solution 300 to the predetermined depth L1, so that a second conductive material may be deposited on the first conductive layer 212.

In the third portion of FIG. 7 (to the immediate right of the second portion), the second conductive material deposited on the first conductive layer 212 may be dried, and a planarization process, e.g., a CMP process, and a cleaning process may be performed, thereby forming the second conductive layer 231 on the first conductive layer 212. That is, compared to the embodiment in FIG. 6, in the embodiment in FIG. 7, the composite portion 220 may be formed first, and then the second conductive layer 231 may be formed.

The fourth portion of FIG. 7 (to the far right) is identical to the fourth portion of FIG. 6, so a detailed description thereof is omitted.

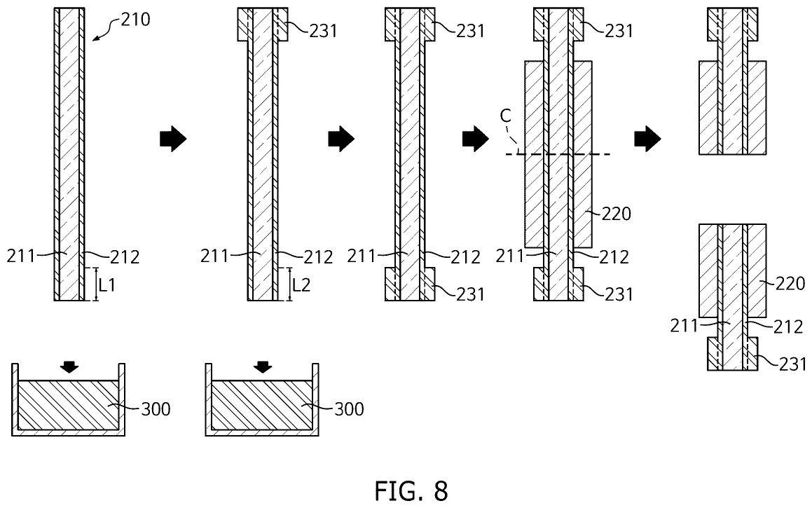

FIG. 8 shows a process of forming an electrode according to an embodiment of the present disclosure.

According to an embodiment, referring to the first portion of FIG. 8 (to the far left), the electrode substrate 210 may be formed to have the width in the longitudinal direction longer than that of the electrode substrate 210 in FIG. 6. For example, the width of the electrode substrate 210 in FIG. 8 may be twice the width of the electrode substrate 210 in FIG. 6, but this may vary.

By immersing one side of the electrode substrate 210 into the second conductive solution 300 to the predetermined depth L1, a second conductive material may be deposited on one side of the first conductive layer 212. The second conductive material deposited on one side of the first conductive layer 212 may be dried, and a planarization process, e.g., a CMP process, and a cleaning process may be performed, thereby forming the second conductive layer 231 on one side of the first conductive layer 212.

According to an embodiment, in the second portion of FIG. 8 (to the immediate right of the first portion) and the third portion of FIG. 8 (to the immediate right of the second portion), the second conductive material may be deposited on the other side of the first conductive layer 212 by immersing the other side of the electrode substrate 210 into the second conductive solution 300 to a predetermined depth L2. The second conductive material deposited on the other side of the first conductive layer 212 may be dried, and a planarization process, e.g., a CMP process, and a cleaning process may be performed, thereby forming the second conductive layer 231 on the other side of the first conductive layer 212.

According to an embodiment, in the fourth portion of FIG. 8 (to the immediate right of the third portion), an active material may be applied onto an area spaced apart from the second conductive layer 231 on the first conductive layer 212, thereby forming the composite portion 220. After the active material has been sufficiently dried, the central area C of the electrode substrate 210 may be cut.

According to an embodiment, in the fifth portion of FIG. 8 (to the far right), the central area of the electrode substrate 210 may be cut, resulting in two electrodes.

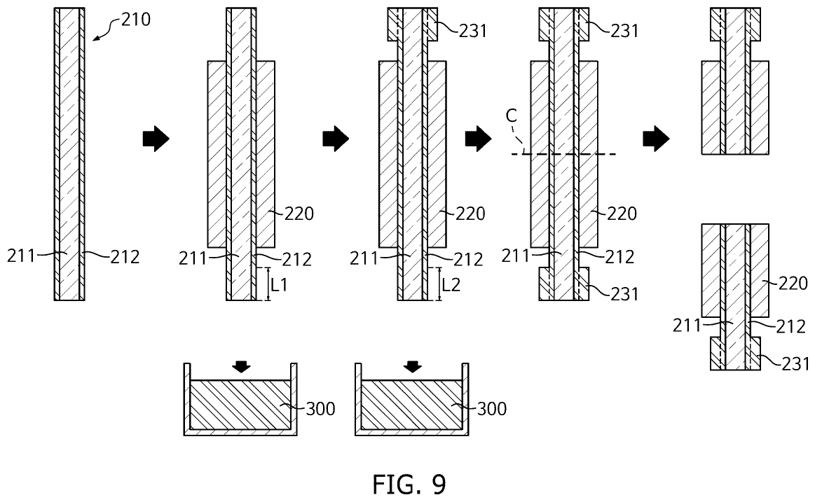

FIG. 9 shows a process of forming an electrode according to an embodiment of the present disclosure.

Referring to FIG. 9, in the first to third portions of FIG. 9 (starting at the far left), the electrode substrate 210 according to an embodiment may be formed, and an active material may be applied to form the composite portion 220. After the formation of the composite portion 220, both ends of the electrode substrate 210 may be immersed in the second conductive solution 300, so that the second conductive layer 231 may be formed on both ends of the first conductive layer 212.

The fourth and fifth portions of FIG. 9 are identical to the fourth and fifth portions of FIG. 8, so a detailed description thereof is omitted.

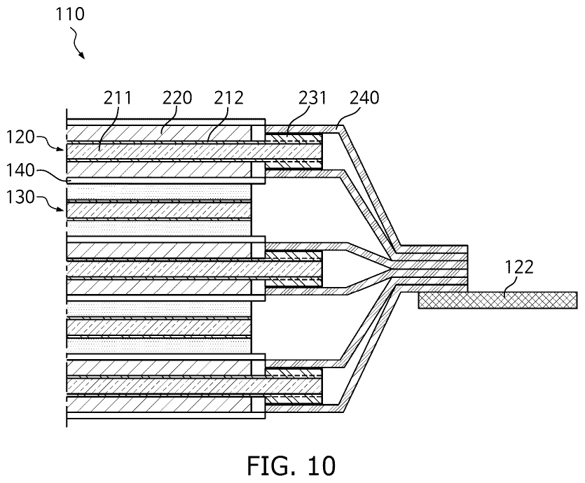

FIG. 10 shows an example of an electrode assembly according to an embodiment of the present disclosure.

Referring to FIG. 10, the electrode assembly 110 according to an embodiment may be formed by stacking the first electrode 120, the second electrode 130, and the separator 140 disposed between the first electrode 120 and the second electrode 130, formed in the shape of a thin plate or a film.

According to an embodiment, at least one of the first electrode 120 and the second electrode 130 may include the electrode substrate 210 including the insulating layer 211 made of an insulating material and the first conductive layer 212 disposed on both sides of the insulating layer 211. The composite portion 220 in which an active material is applied may be formed in an area on the first conductive layer 212, and an uncoated portion in which an active material is not applied may be formed in another area thereon. The second conductive layer 231 may be arranged on an area of the first conductive layer 212 of the uncoated portion. The first conductive layer 212 and the second conductive layer 231 may contain the same conductive material. The electrode tab 240 may be connected onto the second conductive layer 231.

The electrode tab 240 may be connected to the second conductive layer 231 disposed on each of the first uncoated portions of a plurality of the first electrode 120 (stacked). The electrode tab 240 may contain a metal material. A plurality of the electrode tab 240 connected to each of the second conductive layer 231 may be formed in the same direction and may be stacked facing each other. Each of the plurality of the electrode tab 240, which have been stacked, may be electrically connected to the outside by being welded to the first lead tab 122. The electrode tab 240 and the first lead tab 122 may serve as a current path of an external terminal connected to the first electrode 120.

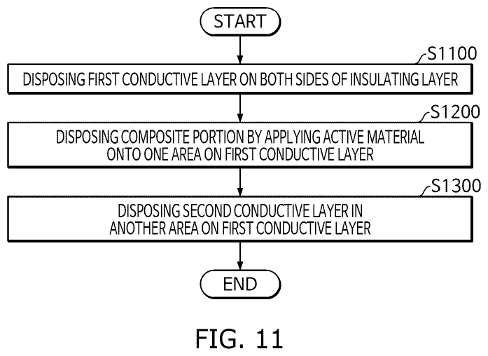

FIG. 11 illustrates a method of manufacturing an electrode according to an embodiment of the present disclosure.

Referring to FIGS. 5 and 11, the method of manufacturing an electrode according to an embodiment of the present disclosure may include disposing a first conductive layer by a first deposition of a first conductive material on both sides of an insulating layer at S1100, disposing a composite portion by applying an active material onto an area on the first conductive layer at S1200, and disposing a second conductive layer by a second deposition of a second conductive material in another area on the first conductive layer at S1300. Here, the first electrode 120 and the second electrode 130 may be either a positive or negative electrode (e.g., one of them is a positive electrode and the other is a negative electrode).

In S1100, the electrode substrate 210 may include the insulating layer 211 and the first conductive layer 212 disposed on both sides of the insulating layer 211. The first conductive layer 212 may be arranged by the first deposition of the first conductive material on both sides of the insulating layer 211. The insulating layer 211 may be formed of a polymer material. For example, the insulating layer 211 may be formed of a polyethylene terephthalate (PET) resin. The insulating layer 211 be formed of a polyester resin such as polytrimethylene terephthalate (PTT), polybutylene terephthalate (PBT), or polyethylene naphthalate (PEN). The first conductive layer 212 may be disposed on both sides of the insulating layer 211. The first conductive layer 212 on the insulating layer 211 may be coated with a metal material such as copper, a copper alloy, nickel, or a nickel alloy or a metal material such as aluminum or an aluminum alloy.

In S1200, an active material may be applied onto an area on the first conductive layer 212 to place the composite portion 220.

According to an embodiment, the composite portion 220 may be formed by applying an active material onto an area on the electrode substrate 210. When the first conductive layer 212 contains aluminum, the composite portion 220 may be formed by applying a positive electrode active material. When the first conductive layer 212 contains copper, the composite portion 220 may be formed by applying a negative electrode active material.

In S1300, the second conductive layer 231 may be disposed by the second deposition of the second conductive material in another area on the first conductive layer 212.

According to an embodiment, the second conductive layer 231 may be disposed in another area, i.e., an uncoated portion, on the electrode substrate 210 where no active material is applied. For example, after the first conductive layer 212 has been deposited on both sides of the insulating layer 211, the second conductive layer 231 may be deposited on an area, for example, one end, of the first conductive layer 212.

According to an embodiment, the second conductive layer 231 may be spaced apart from the composite portion 220 at one end of the uncoated portion 230. For example, the second conductive layer 231 may be arranged with the predetermined gap G (see FIG. 3) from the composite portion 220.

According to an embodiment, the second conductive layer 231 may contain the same conductive material as the first conductive layer 212. For example, when the first conductive layer 212 contains aluminum, the second conductive layer 231 may also contain aluminum. For another example, when the first conductive layer 212 contains copper, the second conductive layer 231 may also contain copper. However, the second conductive layer 231 may be made of a conductive material different from that of the first conductive layer 212.

According to an embodiment, the second conductive layer 231 may be deposited to a thickness greater than that of the first conductive layer 212. As illustrated in FIG. 5, in a first direction, i.e., a Y-axis direction, a second thickness D2 of the second conductive layer 231 may be greater than a first thickness D1 of the first conductive layer 212. The ratio of the first thickness D1 of the first conductive layer 212 and the second thickness D2 of the second conductive layer 231 may be 1:3 to 1:4. For example, when the first thickness D1 of the first conductive layer 212 is about 1 μm, the second thickness D2 of the second conductive layer 231 may be about 3 μm to about 4 μm. However, the thicknesses of the first conductive layer 212 and the second conductive layer 231 may vary depending on design conditions.

According to an embodiment, the electrode tab 240 may be connected onto the second conductive layer 231. The second conductive layer 231 may be placed between the electrode tab 240 and the first conductive layer 212, so that the insulating layer 211 may not be damaged in the process of connecting the electrode tab 240 to the second conductive layer 231.

Generally, copper or aluminum is widely used as the material of electrodes of electrode assemblies. However, in the case of aluminum, when a short circuit occurs, aluminum may come into contact with a negative electrode active material, which may cause a fire.

To solve such a problem, a method of manufacturing an electrode including a composite substrate where a metal layer is placed on both sides of a polymer insulating layer such as polyethylene terephthalate (PET) has been proposed. In addition, a tab made of metal is welded to the metal layer placed on the upper and lower surfaces of the insulating layer, but there is a problem that the insulating layer is damaged by the welding process.

Although the present disclosure has been described above with respect to embodiments thereof, the present disclosure is not limited thereto. Various modifications and variations can be made thereto by those skilled in the art within the spirit of the present disclosure and the equivalent scope of the appended claims.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. An electrode, comprising:
an electrode substrate comprising an insulating layer and a first conductive layer on opposite sides of the insulating layer;
a composite portion having an active material thereon in an area of the electrode substrate;
an uncoated portion having no active material thereon in another area of the electrode substrate; and
a second conductive layer on the first conductive layer in the uncoated portion.

2. The electrode as claimed in claim 1, wherein a second thickness of the second conductive layer is greater than a first thickness of the first conductive layer.

3. The electrode as claimed in claim 2, wherein a ratio of the first thickness and the second thickness is 1:3 to 1:4.

4. The electrode as claimed in claim 1, wherein the second conductive layer is spaced apart from the composite portion at one end of the uncoated portion.

5. The electrode as claimed in claim 1, wherein the first conductive layer and the second conductive layer comprise a same conductive material.

6. The electrode as claimed in claim 1, further comprising an electrode tab welded onto the second conductive layer.

7. The electrode as claimed in claim 1, wherein:
if the electrode is a positive electrode, a ratio of a thickness of the insulating layer and a thickness of the first conductive layer is 3:1 to 4:1, and
if the electrode is a negative electrode, the ratio of the thickness of the insulating layer and the thickness of the first conductive layer is 2:1 to 3:1.

8. A secondary battery, comprising:
an electrode assembly comprising a first electrode, a second electrode, and a separator between the first electrode and the second electrode; and
a case accommodating the electrode assembly,
wherein at least one of the first electrode and the second electrode comprises:
an electrode substrate comprising an insulating layer and a first conductive layer on opposite sides of the insulating layer;
a composite portion having an active material thereon in an area of the electrode substrate;
an uncoated portion having no active material thereon in another area of the electrode substrate; and
a second conductive layer on the first conductive layer in the uncoated portion.

9. The secondary battery as claimed in claim 8, wherein a second thickness of the second conductive layer is greater than a first thickness of the first conductive layer.

10. The secondary battery as claimed in claim 9, wherein a ratio of the first thickness and the second thickness is 1:3 to 1:4.

11. The secondary battery as claimed in claim 8, wherein the second conductive layer is spaced apart from the composite portion at one end of the uncoated portion.

12. The secondary battery as claimed in claim 8, wherein the first conductive layer and the second conductive layer comprise a same conductive material.

13. The secondary battery as claimed in claim 8, further comprising an electrode tab welded onto the second conductive layer.

14. The secondary battery as claimed in claim 8, further comprising an electrode tab connected to each of a plurality of the first electrode or a plurality of the second electrode and a lead tab connected to the electrode tab.

15. A method of manufacturing an electrode, the method comprising:
disposing a first conductive layer by a first deposition of a first conductive material on opposite sides of an insulating layer;
disposing a composite portion by applying an active material onto an area on the first conductive layer; and
disposing a second conductive layer by a second deposition of a second conductive material onto another area on the first conductive layer.

16. The method as claimed in claim 15, wherein disposing the second conductive layer comprises disposing the second conductive layer having a second thickness greater than a first thickness of the first conductive layer.

17. The method as claimed in claim 16, wherein a ratio of the first thickness and the second thickness is 1:3 to 1:4.

18. The method as claimed in claim 15, wherein disposing the second conductive layer comprises disposing the second conductive layer spaced apart from the composite portion at one end of the first conductive layer.

19. The method as claimed in claim 15, wherein the first conductive material and the second conductive material are a same material.

20. The method as claimed in claim 15, further comprising welding an electrode tab onto the second conductive layer.
